(19) United States
(12) Patent Application Publication
(10) Pub. No.: US 2006/0139813 A1
(43) Pub. Date: Jun. 29, 2006

(54) Bearing mechanism for head used in magnetic disk drive and magnetic disk drive having the same

(75) Inventors: Satoshi Hayakawa, Kanagawa (JP); Takeshi Chawanya, Kanagawa (JP); Kohichi Takeuchi, Kanagawa (JP); Takao Suzuki, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/305,456

(22) Filed: Dec. 15, 2005

(30) Foreign Application Priority Data
Dec. 27, 2004 (JP) 2004-376621

(51) Int. Cl. G11B 5/55

(52) U.S. Cl. 360/265.2

(57) ABSTRACT

Embodiments of the invention provide a bearing mechanism for a head used in a magnetic disk drive capable of preventing scattering of dust and dirt at a high level and a magnetic disk drive having the same. In one embodiment, a base is provided with a bearing hole. An inner shaft is joined to the bearing hole. The inner shaft is inserted internally in an outer sleeve mounted with a head stack assembly. The outer sleeve is swingably connected to the inner shaft by way of upper and lower bearing mechanisms. A receiving surface is formed around the bearing hole on the base. The receiving surface is higher by a predetermined height than a basic plane of the base. An extended portion is formed on an end portion on a lower side (the end facing the base) of the outer sleeve. A labyrinth seal structure is provided between an end face of the extended portion and the receiving surface.

### CROSS-REFERENCES TO RELATED APPLICATIONS

This application claims priority from Japanese Patent Application No. JP2004-376621, filed Dec. 27, 2004, the entire disclosure of which is incorporated herein by reference.

### BACKGROUND OF THE INVENTION

The present invention relates to improvements on a bearing mechanism for a head which swingably supports a head stack assembly used in a magnetic disk drive and a magnetic disk drive having the bearing mechanism.

With the recent trend toward increased recording density in magnetic disk drives, the distance between a magnetic disk and a magnetic head has become narrower and narrower. This trend has made it more and more important to reduce the amount of dust and dirt in the magnetic disk drive in order to reduce damage to the magnetic disk.

For example, Patent Document 1 (Japanese Patent Laid-open No. Hei 5-144235) shown below discloses a sealing structure for preventing scattering of dust and dirt produced from a sliding portion of a member for guiding and supporting a voice coil motor (VCM).

In the aforementioned prior art, a labyrinth seal structure is provided by defining a minute clearance between an outer surface of the VCM and the support base. The prior art has not, however, been effective enough in preventing dust and dirt from scattering. This is because the seal structure for the bearing mechanism used for the head failed to offer sufficient sealing performance.

FIG. 4 is a cross sectional view showing the structure of a conventional head bearing mechanism. Referring to FIG. 4, a base 10 is provided with a bearing hole 12. An inner shaft 16, in which a shaft 14 is inserted, is fitted in the bearing hole 12. The inner shaft 16 is thereby joined to the base 10. A head stack assembly included in the magnetic disk drive not shown is mounted on an outer sleeve 18. The outer sleeve 18 is swingably connected to the inner shaft 16 by upper and lower bearing mechanisms 20.

Each of the bearing mechanisms 20 includes an outer race 22, an inner race 24, and a ball bearing 26 clamped therebetween. Lubricating grease is present in a gap between the ball bearing 26 and the outer race 22, and between the ball bearing 26 and the inner race 24. Only a sealing structure not shown has conventionally been formed between the outer race 22 and the inner race 24, offering only an insufficient sealing performance.

### BRIEF SUMMARY OF THE INVENTION

The present invention has been made in view of the problems in the prior art described above. It is, therefore, a feature of the present invention to provide a bearing mechanism for a head used in a magnetic disk drive capable of preventing scattering of dust and dirt at a high level and a magnetic disk drive having the same.

In accordance with an aspect of the present invention, a bearing mechanism for a head used in a magnetic disk drive comprises: a base including a bearing hole; an inner shaft joined to the bearing hole in the base; a receiving surface formed to surround the bearing hole in the base, the receiving surface being higher by a predetermined height than a basic plane of the base; an outer sleeve mounted with a head stack assembly included in the magnetic disk drive; a bearing structure swingably connecting the outer sleeve, in which the inner shaft is internally inserted, to the inner shaft; and a labyrinth seal structure provided between an end face of the outer sleeve, facing the base, and the receiving surface.

In some embodiments, the labyrinth seal structure includes a gap defined between the end face and the bearing surface, having a clearance of about 0.12±0.03 mm and a length of about 0.7 to 1.0 mm.

The bearing mechanism for a head used in a magnetic disk drive is further characterized by comprising a protruded portion formed on the receiving surface, the protruded portion surrounding an outer surface of the outer sleeve; and a labyrinth seal structure provided between an inner surface of the protruded portion and the outer surface of the outer sleeve.

The present invention also provides a magnetic disk drive including the aforementioned bearing mechanism for a head used in a magnetic disk drive.

### BRIEF DESCRIPTION OF THE DRAWINGS

FIG. 1 is a cross sectional view showing the structure of a bearing mechanism for a head used in a magnetic disk drive according to an embodiment of the present invention.

FIG. 2 is an enlarged view showing a portion near the lower bearing mechanism, labeled an area A enclosed by a chain line in FIG. 1.

FIG. 3 is a cross sectional view showing the structure of a modification of the bearing mechanism according to another embodiment of the present invention.

FIG. 4 is a cross sectional view showing the structure of a conventional bearing mechanism for a head.

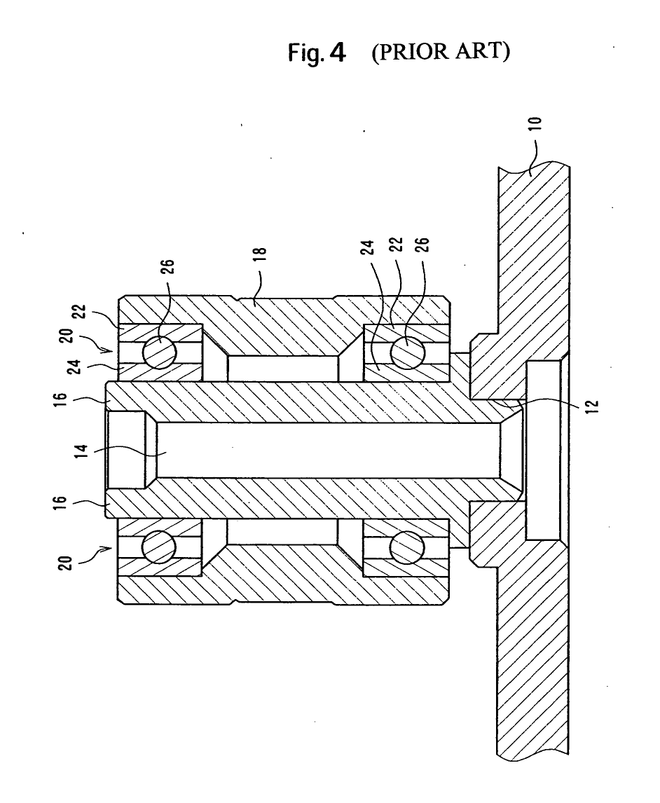

### DETAILED DESCRIPTION OF THE INVENTION

Specific embodiments for carrying out the present invention (hereinafter referred to as the embodiment) will be described with reference to the accompanying drawings.

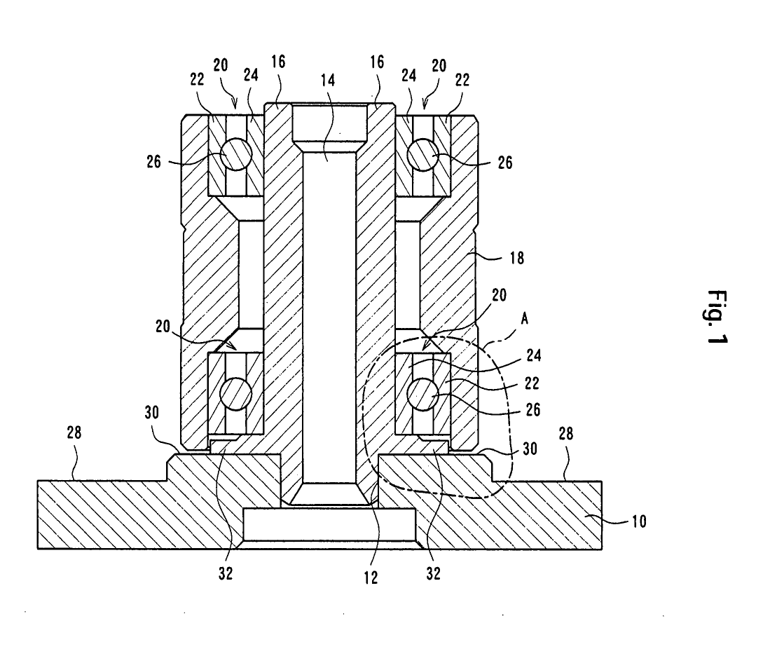

FIG. 1 is a cross sectional view showing the structure of a bearing mechanism for a head used in a magnetic disk drive according to an embodiment of the present invention. Referring to FIG. 1, a base 10 is provided with a bearing hole 12. An inner shaft 16, in which a shaft 14 is inserted, is fitted in the bearing hole 12. The inner shaft 16 is thereby joined to the base 10. A head stack assembly included in the magnetic disk drive not shown is mounted on an outer sleeve 18. The inner shaft 16 is internally inserted in the outer sleeve 18. The outer sleeve 18 is swingably connected to the inner shaft 16 by upper and lower bearing mechanisms 20.

Each of the bearing mechanisms 20 includes an outer race 22, an inner race 24, and a ball bearing 26 clamped therebetween. Lubricating grease is present in a gap between the ball bearing 26 and the outer race 22, and between the ball bearing 26 and the inner race 24.

The base 10 is provided with a receiving surface 30 around the bearing hole 12. The receiving surface 30 is higher by a predetermined height than a basic plane 28 of the base 10. The basic plane 28 refers to a surface on a side, in which the bearing hole 12 is extended, of an entire surface of a portion in which the base 10 is formed with a thickness according to basic specifications thereof.

A flange 32 is formed near an end portion of the inner shaft 16 that is fitted into the bearing hole 12. A face of the flange 32 is in contact with the receiving surface 30. The receiving surface 30 thus supports the inner shaft 16 by way of the flange 32.

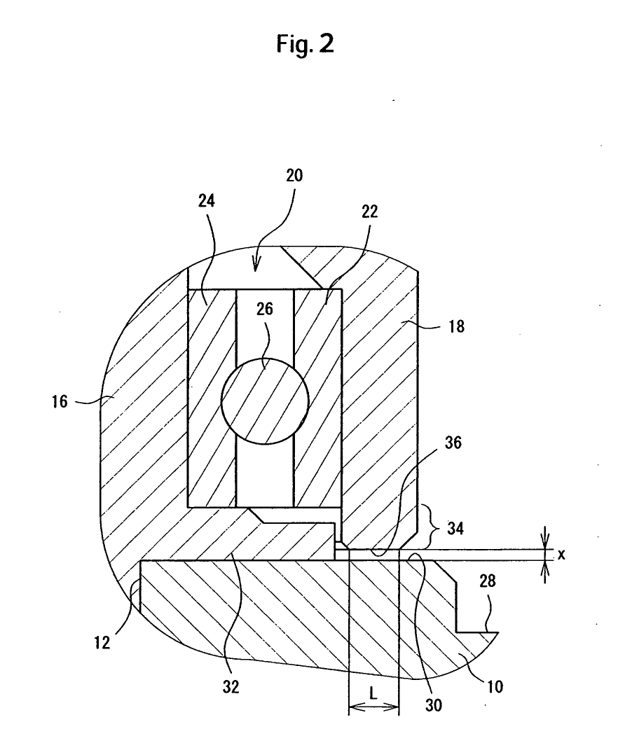

FIG. 2 is an enlarged view showing a portion near the lower bearing mechanism 20, labeled an area A enclosed by a chain line in FIG. 1. Referring to FIG. 2, an extended portion 34 is formed on an end portion on a lower side (the end adjacent to the base 10) of the outer sleeve 18. An end face 36 of the extended portion 34 and the receiving surface 30 are machined to offer a clearance x therebetween measuring about 0.12±0.03 mm. A labyrinth seal structure is thereby formed in the clearance x. A length L of the labyrinth seal structure may measure, for example, about 0.7 to 1.0 mm. The length L is appropriately set according to the size of the bearing mechanism, the size of a chamfered corner of the extended portion 34, and the like.

The length of the receiving surface 30 from the bearing hole 12 is established as appropriately such that the flange 32 can be supported and the labyrinth seal structure can be provided in association with the end face 36 of the extended portion 34. According to the embodiment of the present invention, a surface in contact with the flange 32 and a surface providing the labyrinth seal structure in association with the end face 36 are formed on the same plane as the receiving surface 30. This facilitates formation and polishing of the surface.

By forming this labyrinth seal structure, it is possible to effectively prevent dust and dirt resulting from grease or the like used in the bearing mechanisms 20 from being scattered internally the magnetic disk drive. In addition, the aforementioned labyrinth seal structure can be formed by making only minor changes of a conventional head bearing mechanism. Cleanness inside the magnetic disk drive can therefore be enhanced simply and at low cost.

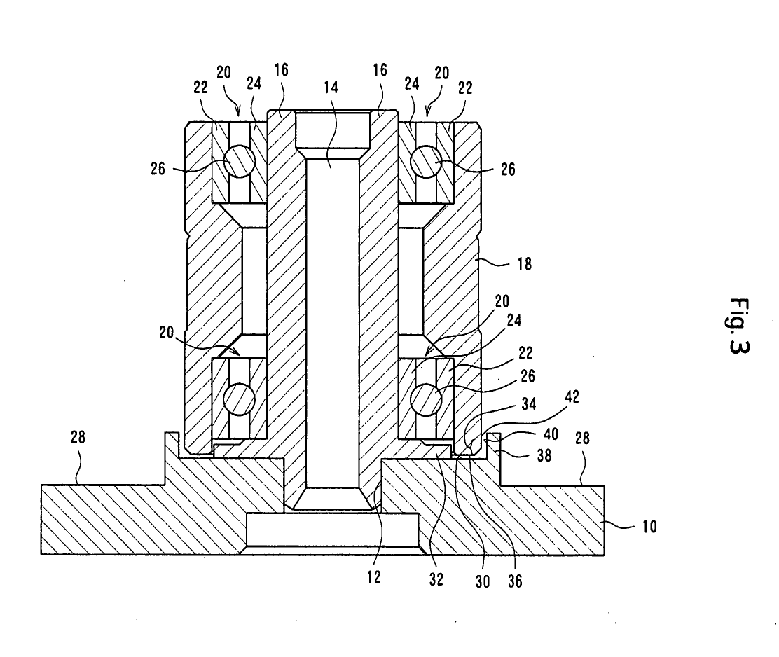

FIG. 3 is a cross sectional view showing the structure of a modification of the head bearing mechanism according to the present invention. Referring to FIG. 3, the modified example of the head bearing mechanism is characterized in that a protruded portion 38 surrounding an outer surface of an extended portion 34 of an outer sleeve 18 is formed on a receiving surface 30. A labyrinth seal structure of the same type as that described with reference to FIG. 2 is formed between an inner surface 40 of the protruded portion 38 and an outer surface 42 of the extended portion 34.

According to the modification, the labyrinth seal structure is formed between the inner surface 40 of the protruded portion 38 and the outer surface 42 of the extended portion 34, in addition to an area between the end face 36 of the extended portion 34 and the receiving surface 30. Accordingly, scattering of dust and dirt can be even more positively prevented.

The present invention also includes a magnetic disk drive including the bearing mechanism for the head according to each of the foregoing embodiments thereof.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A bearing mechanism for a head used in a magnetic disk drive, comprising:
a base including a bearing hole;
an inner shaft joined to the bearing hole in the base;
a receiving surface formed to surround the bearing hole in the base, the receiving surface being higher by a predetermined height than a basic plane of the base;
an outer sleeve mounted with a head stack assembly included in the magnetic disk drive;
a bearing structure swingably connecting the outer sleeve, in which the inner shaft is internally inserted, to the inner shaft; and
a labyrinth seal structure provided between an end face of the outer sleeve, facing the base, and the receiving surface.

2. A magnetic disk drive comprising the bearing mechanism for a head used in a magnetic disk drive according to claim 1.

3. A bearing mechanism for a head used in a magnetic disk drive according to claim 1,
wherein the labyrinth seal structure includes a gap defined between the end face and the receiving surface, the gap having a clearance of about 0.12±0.03 mm and a length of about 0.7 to 1.0 mm.

4. A magnetic disk drive comprising the bearing mechanism for a head used in a magnetic disk drive according to claim 3.

5. A bearing mechanism for a head used in a magnetic disk drive according to claim 1, further comprising:
a protruded portion formed on the receiving surface, the protruded portion surrounding an outer surface of the outer sleeve; and
a labyrinth seal structure provided between an inner surface of the protruded portion and the outer surface of the outer sleeve.

6. A magnetic disk drive comprising the bearing mechanism for a head used in a magnetic disk drive according to claim 5.

7. A bearing mechanism for a head used in a magnetic disk drive, comprising:
a base including a bearing hole;
an inner shaft joined to the bearing hole in the base;
a receiving surface formed to surround the bearing hole in the base;
an outer sleeve mounted with a head stack assembly included in the magnetic disk drive;
a bearing structure swingably connecting the outer sleeve, in which the inner shaft is internally inserted, to the inner shaft; and
a gap defined between an end face of the outer sleeve, facing the base, and the receiving surface, the gap having a clearance of about 0.12±0.03 mm and a length of about 0.7 to 1.0 mm.

8. A magnetic disk drive comprising the bearing mechanism for a head used in a magnetic disk drive according to claim 7.

9. A bearing mechanism for a head used in a magnetic disk drive according to claim 7, further comprising:
a protruded portion formed on the receiving surface, the protruded portion surrounding an outer surface of the outer sleeve; and
a gap provided between an inner surface of the protruded portion and the outer surface of the outer sleeve.

10. A magnetic disk drive comprising the bearing mechanism for a head used in a magnetic disk drive according to claim 9.

11. A bearing mechanism for a head used in a magnetic disk drive according to claim 7, wherein the receiving surface is higher by a predetermined height than a basic plane of the base.

12. A magnetic disk drive comprising the bearing mechanism for a head used in a magnetic disk drive according to claim 11.

13. A bearing mechanism for a head used in a magnetic disk drive, comprising:
a base including a bearing hole;
an inner shaft joined to the bearing hole in the base;
a receiving surface formed to surround the bearing hole in the base;
an outer sleeve mounted with a head stack assembly included in the magnetic disk drive;
means for swingably connecting the outer sleeve, in which the inner shaft is internally inserted, to the inner shaft; and
a labyrinth seal structure provided between an end face of the outer sleeve, facing the base, and the receiving surface.

14. A magnetic disk drive comprising the bearing mechanism for a head used in a magnetic disk drive according to claim 13.

15. A bearing mechanism for a head used in a magnetic disk drive according to claim 13,
wherein the labyrinth seal structure includes a gap defined between the end face and the receiving surface, the gap having a clearance of about 0.12±0.03 mm and a length of about 0.7 to 1.0 mm.

16. A magnetic disk drive comprising the bearing mechanism for a head used in a magnetic disk drive according to claim 15.

17. A bearing mechanism for a head used in a magnetic disk drive according to claim 13, further comprising:
a protruded portion formed on the receiving surface, the protruded portion surrounding an outer surface of the outer sleeve; and
a labyrinth seal structure provided between an inner surface of the protruded portion and the outer surface of the outer sleeve.

18. A magnetic disk drive comprising the bearing mechanism for a head used in a magnetic disk drive according to claim 17.

19. A bearing mechanism for a head used in a magnetic disk drive according to claim 13, wherein the receiving surface is higher by a predetermined height than a basic plane of the base.

20. A magnetic disk drive comprising the bearing mechanism for a head used in a magnetic disk drive according to claim 19.
